(19) United States
(12) Patent Application Publication
(10) Pub. No.: US 2006/0024115 A1
(43) Pub. Date: Feb. 2, 2006

(54) Printing apparatus and print control apparatus

(75) Inventor: Shinya Komatsu, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/173,150

(22) Filed: Jul. 5, 2005

(30) Foreign Application Priority Data
Jul. 2, 2004 (JP) 2004-196752

(51) Int. Cl. B41J 15/02

(52) U.S. Cl. 400/613

(57) ABSTRACT

A printing apparatus etc. which is highly convenient for users is realized. A printing apparatus includes: an attachment section for attachment of a roll paper; a print head for printing on the roll paper which is attached to the attachment section; and a controller for printing, on the roll paper which is attached to the attachment section using the print head, a plurality of pieces of information about at least either one of the printing apparatus and the roll paper, wherein the controller prints, on the roll paper, selected information which has been selected by a user from among the plurality of pieces of information.

### CROSS-REFERENCE TO RELATED APPLICATIONS

The present application claims priority upon Japanese Patent Application No. 2004-196752 filed on Jul. 2, 2004, which is incorporated herein by reference.

### BACKGROUND OF THE INVENTION

1. Field of the Invention

The present invention relates to printing apparatuses and print control apparatuses.

2. Description of the Related Art

Printing apparatuses which are provided with a print head and an attachment section for attachment of a roll paper are well known. Such printing apparatuses perform printing on the roll paper attached to the attachment section using the print head.

### SUMMARY OF THE INVENTION

There are cases in which a user removes the roll paper, which is attached to the printing apparatus, before using up the roll paper. As an example, this situation arises when the user exchanges the roll paper attached to the printing apparatus for another type of roll paper in order to perform printing on a different type of roll paper.

When the user does not use the removed roll paper for a certain period of time, the user has to store that roll paper, but the following problems might arise when reusing that roll paper. Namely, there is a possibility that the user might get confused as to whether or not attaching that roll paper to the printing apparatus and using it is appropriate, or which printing apparatus to attach that roll paper.

In order to resolve such problems, a printing apparatus is effective which is capable of printing, on the roll paper, multiple instances of information about the roll paper, including remaining amount, paper type, size, and so on, and information about the printing apparatus, including model name of the printing apparatus, supplier of the printing apparatus, and so on. If this information is printed when the user removes the roll paper from the printing apparatus before using it up, the user can refer to this information when reusing the roll paper to determine whether it is appropriate to attach and use the roll paper on the printing apparatus and which printing apparatus to attach that roll paper.

On the other hand, there are also cases where the user wants to select a few of the plurality of pieces of information and have only those selected pieces of information be printed on the roll paper, when taking into consideration conserving the roll paper. For example, this situation arises when the user considers it unnecessary for all the information to be printed on the roll paper for determining whether it is appropriate to attach and use the roll paper on the printing apparatus and which printing apparatus to attach the roll paper in. This situation arises also when the user simply want to see only a few of the plurality of pieces of information, and not for determining whether it is appropriate to attach and use the roll paper on the printing apparatus and which printing apparatus to attach the roll paper in.

The present invention was arrived at in light of the foregoing issues, and it is an object thereof to achieve a printing apparatus and a print control apparatus that are highly convenient for users.

A primary aspect of the present invention is a printing apparatus such as the following.

A printing apparatus is provided with:
an attachment section for attachment of a roll paper;
a print head for printing on the roll paper which is attached to the attachment section; and
a controller for printing, on the roll paper which is attached to the attachment section using the print head, a plurality of pieces of information about at least either one of the printing apparatus and the roll paper, wherein the controller prints, on the roll paper, selected information which has been selected by a user from among the plurality of pieces of information.

Other features of the present invention will become clear through the accompanying drawings and the following description.

### BRIEF DESCRIPTION OF THE DRAWINGS

For a more complete understanding of the present invention and the advantages thereof, reference is now made to the following description taken in conjunction with the accompanying drawings.

FIG. 1 is an explanatory diagram showing an external configuration of a print control apparatus 700.

FIG. 2 is a block diagram showing part of the configuration of the print control apparatus 700 shown in FIG. 1.

FIG. 3 is an explanatory diagram showing an external configuration of a printer 10.

FIG. 4 is a block diagram showing the configuration of a printer.

FIG. 5 is a schematic diagram schematically expressing some of the configuration components of the printer 10.

FIG. 6 is a schematic diagram showing how selected information is printed on a roll paper 1.

FIG. 7 is a flowchart for describing operation of the print control apparatus 700.

FIG. 8A is a (first) diagram showing a user interface screen for a printer driver 796.

FIG. 8B is a (second) diagram showing a user interface screen for the printer driver 796.

FIG. 9 is a flowchart for describing operation of the printer 10.

FIG. 10 is a flowchart for describing operation of the printer 10.

FIG. 11A is a schematic diagram showing how a mark sheet is printed on the roll paper 1.

FIG. 11B is a schematic diagram showing how the mark sheet printed on the roll paper 1 is marked by a user.

FIG. 12 is a schematic diagram showing the movement of the roll paper 1.

### DETAILED DESCRIPTION OF PREFERRED EMBODIMENTS

At least the following matters will be made clear by the present specification and the accompanying drawings.

A printing apparatus includes:
an attachment section for attachment of a roll paper;
a print head for printing on the roll paper which is attached to the attachment section; and
a controller for printing, on the roll paper which is attached to the attachment section using the print head, a plurality of pieces of information about at least either one of the printing apparatus and the roll paper, wherein the controller prints, on the roll paper, selected information which has been selected by a user from among the plurality of pieces of information.

This kind of printing apparatus makes it possible to realize a printing apparatus with a high level of convenience for users.

Further, the printing apparatus may further include a selection accepting section for accepting the selection of the selected information by the user; and the controller may print, on the roll paper, the selected information which has been selected through the selection accepting section.

This kind of printing apparatus makes it possible to print the selected information on the roll paper even when the printing apparatus is not electrically connected to a computer.

Further, the controller may print, on the roll paper, an image for making the user select the selected information; the printing apparatus may include a reading member for reading the image, and the reading member may read the image after the user has selected the selected information using the image; and the controller may print, on the roll paper, the selected information which has been specified based on the image read by the reading member.

This kind of printing apparatus makes it possible to realize a printing apparatus with a particularly high level of convenience for users who are not skilled at operating printing apparatuses or computers.

Further, the printing apparatus may further include a movable moving member which is provided with the print head; and the moving member may also be provided with the reading member.

With this kind of printing apparatus, it is possible to realize image reading with a simple mechanical configuration. It is also possible for the print head and the reading member to share the moving member.

Further, the controller may print, on the roll paper, an image for making the user select the selected information and then may feed back the roll paper after the user has selected the selected information using the image; the reading member may read the image printed on the roll paper which has been fed back; and the controller may print, on the roll paper, the selected information specified based on the image read by the reading member.

This kind of printing apparatus makes it possible to eliminate labor for the user.

Further, the printing apparatus may further include a cutting member for cutting the roll paper attached to the attachment section; and the controller may determine, based on the selected information which has been selected by the user, whether or not to cut the roll paper by moving the cutting member after printing the selected information.

This kind of printing apparatus makes it possible to further improve convenience for the user.

Further, a printing apparatus includes:
an attachment section for attachment of a roll paper;
a print head for printing on the roll paper which is attached to the attachment section;
a controller for printing, on the roll paper which is attached to the attachment section using the print head, a plurality of pieces of information about at least either one of the printing apparatus and the roll paper, wherein the controller prints, on the roll paper, selected information which has been selected by a user from among the plurality of pieces of information, and also prints, on the roll paper, an image for making the user select the selected information;
a reading member for reading the image, wherein the reading member reads the image after the user has selected the selected information using the image;
a movable moving member which is provided with the print head; and
a cutting member for cutting the roll paper attached to the attachment section;
wherein the controller prints, on the roll paper, the selected information which has been specified based on the image read by the reading member;
wherein the moving member is also provided with the reading member;
wherein the controller prints, on the roll paper, an image for making the user select the selected information and then feeds back the roll paper after the user has selected the selected information using the image;
wherein the reading member reads the image printed on the roll paper which has been fed back;
wherein the controller prints, on the roll paper, the selected information specified based on the image read by the reading member; and
wherein the controller determines, based on the selected information which has been selected by the user, whether or not to cut the roll paper by moving the cutting member after printing the selected information.

With such a printing apparatus, it is possible to attain almost all of the effects mentioned above, and thus achieve the object of the present invention more effectively.

Further, a print control apparatus includes:
an attachment section for attachment of a roll paper;
a print head for printing on the roll paper which is attached to the attachment section; and
a controller for printing, on the roll paper which is attached to the attachment section using the print head, a plurality of pieces of information about at least either one of the print control apparatus and the roll paper, wherein the controller prints, on the roll paper, selected information which has been selected by a user from among the plurality of pieces of information.

This kind of print control apparatus makes it possible to realize a print control apparatus with a high level of convenience for users.

Further, the print control apparatus may further include a selection accepting section for accepting the selection of the selected information by the user; and the controller may print, on the roll paper, the selected information which has been selected through the selection accepting section.

With this kind of print control apparatus, a print control apparatus is realized which allows a user to execute selection of selected information on a desk on which a computer is placed.

Example of Configuration of Print Control Apparatus

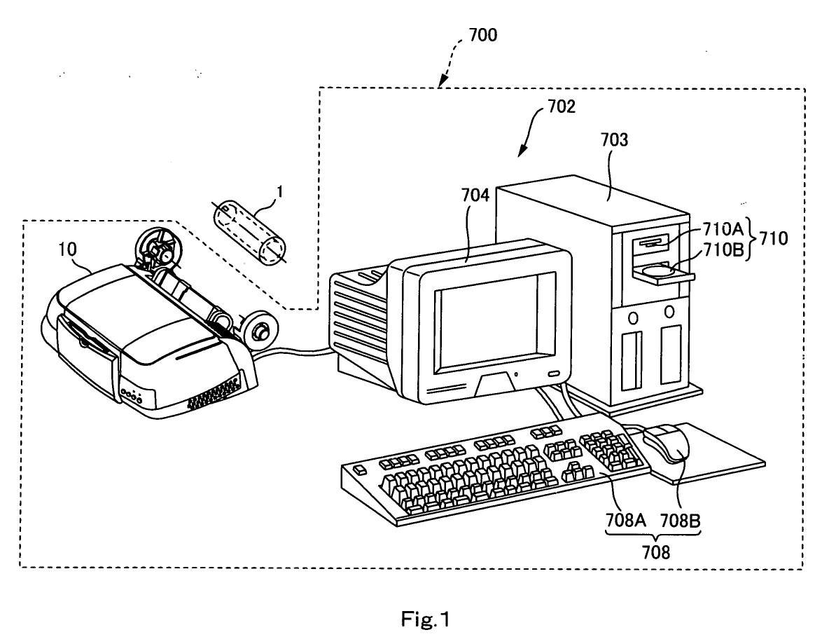

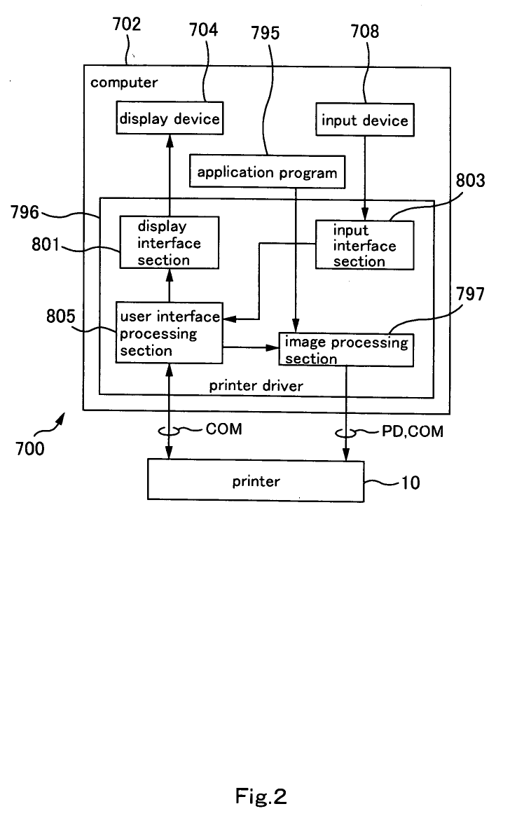

First, a description is made of a print control apparatus according to the present embodiment, with reference to FIG. 1 and FIG. 2.

FIG. 1 is an explanatory diagram showing the external configuration of a print control apparatus 700. FIG. 2 is a block diagram showing part of the configuration of the print control apparatus 700 shown in FIG. 1.

The print control apparatus 700 is provided with an ink jet printer 10 (hereafter also referred to as “printer”) as an example of a printing apparatus and a computer 702 which can communicate with the printer 10. The computer 702 is provided with a computer body 703; a display device 704 such as a CRT (Cathode Ray Tube), a liquid crystal display device, and a plasma display; an input device 708 such as a keyboard 708A and a mouse 708B; a reading device 710 such as an FD (Flexible Drive) apparatus 710A, a CD-ROM drive apparatus 710B, an MO (Magneto Optical) disk drive apparatus (not shown), and a DVD (Digital Versatile Disk) apparatus (not shown); an internal memory (not shown) such as a RAM; and an external memory (not shown) such as a hard disk drive unit.

The printer 10 is a printing apparatus for printing print images on a medium such as paper, cloth, or film. The printer 10 according to the present embodiment is configured such that a roll paper 1 can be attached and removed, and the printer 10 prints the print images on the roll paper 1 which is attached to the printer 10. FIG. 1 shows the roll paper 1 which can be attached to and removed from the printer 10, together with the print control apparatus 700.

The computer 702 is electrically connected to the printer 10, and is provided with an operating system, an application program 795 which operates under the operating system, and a printer driver 796. The printer driver 796 is provided with an image processing section 797, a display interface section 801, an input interface section 803, and a user interface processing section 805.

The application program 795 is a program on the computer 702 for letting the printer 10 perform printing. Image data AD in the application program is sent to the printer driver 796 in response to a print execution instruction from the application program 795.

The image processing section 797 is provided with functionality for receiving the image data AD which can be interpreted by the application program 795, converting it to print data PD which can be interpreted by the printer 10, and sending the converted print data PD to the printer 10 together with control signals COM. In other words, the image processing section 797 of the printer driver 796 instructs the printer 10 to execute printing after performing the above-mentioned image processing. The image processing section 797 implements, for example, conversion of resolution, conversion of color components, and so on, in order to realize this functionality.

The display interface section 801 is provided with functionality for displaying a variety of user interface windows related to the printer 10 on the display device 704. The input interface section 803 is provided with functionality for accepting input information which is input through the user interface window by the user using the input device 708.

The user interface processing section 805 is provided with functionality to provide an interface between the printer 10 and the display interface section 801 or the input interface section 803. For example, the user interface processing section 805 receives the input information from the input interface section 803 and interprets the input information. Then the control signals COM are sent to the printer 10 and the image processing section 797. Furthermore, the user interface processing section 805 interprets the control signals COM received from the printer 10 and sends the information about displaying to the display interface section 801.

The printer driver 796 which is provided in the computer 702 is supplied in a form stored on a storage medium which can be read by a computer. As these storage media, various types of computer-readable media can be used, such as flexible disks, CD-ROMS, magneto-optic disks, IC cards, ROM cartridges, punchcards, printed material on which a code such as a barcode is printed, storage devices inside a computer (memories such as a RAM or ROM), and storage devices outside a computer. Also, such a computer program can be downloaded onto the computer 702 via the Internet.

In the above description, an example was described in which the print control apparatus 700 is configured such that the printer 10 is electrically connected to the computer 702, which is provided with the computer body 703, the display device 704, the input device 708, the reading device 710, the internal memory, and the external memory; however, the printer 10 may be provided with some of the functions or mechanisms provided in the computer body 703, the display device 704, the input device 708, the reading device 710, the internal memory, and/or the external memory. For example, the printer 10 can be configured so as to have an image processing section for carrying out image processing, a display section for carrying out various types of displaying, and a storage media inserting section to which storage media storing image data captured by a digital camera or the like can be inserted.

Accordingly, in a narrow sense, the “print control apparatus” means a computer system which includes the printer 10 and the computer 702, but in a broader sense it means a printing apparatus such as the printer 10, provided with the functions/mechanisms relating to the computer 702.

Example of Configuration of Printing Apparatus

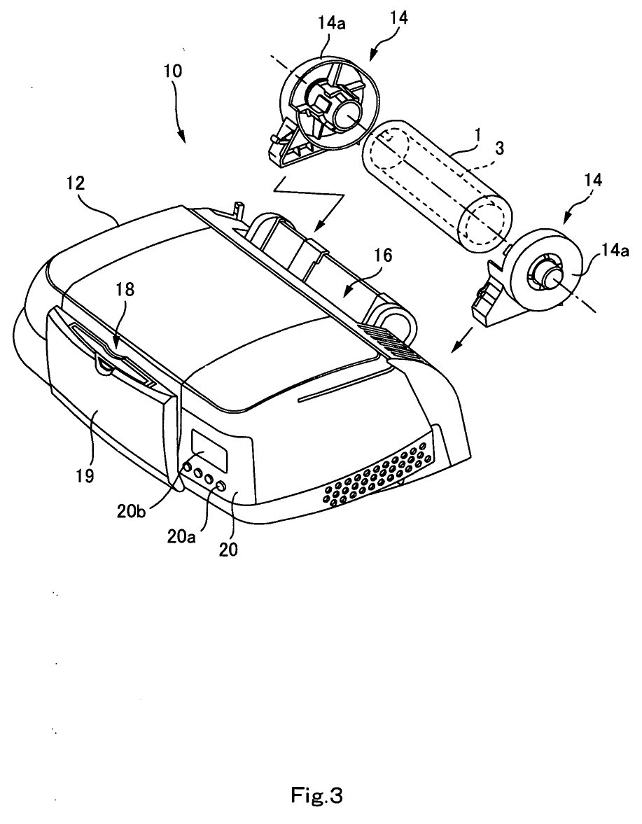

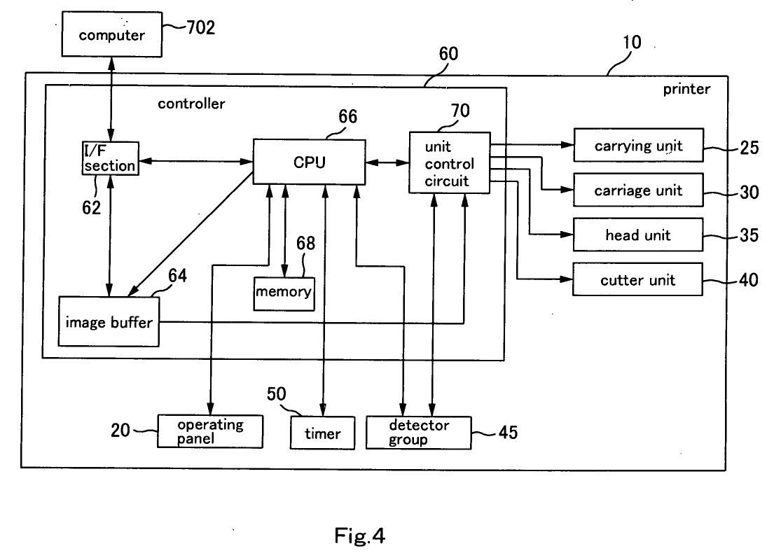

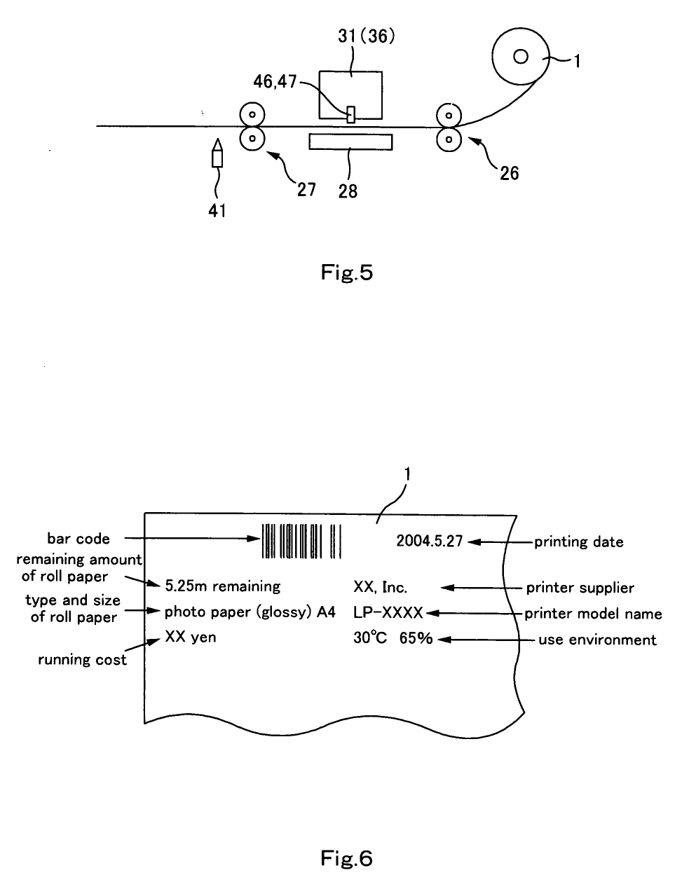

Next, the printer 10 is described as an example of a printing apparatus, with reference to FIG. 3 through FIG. 5. FIG. 3 is an explanatory diagram showing the external configuration of a printer 10. FIG. 4 is a block diagram showing the configuration of the printer. FIG. 5 is a schematic diagram schematically expressing some of the configuration components of the printer 10. Note that in FIG. 3, a roll paper attachment unit 14 is shown removed from the housing 12 of the printer 10 and the roll paper 1 in order to clearly show the configuration of holders 14a, described below.

<<<External Configuration of Printer 10>>>

First, the external configuration of the printer 10 is described with reference to FIG. 3. The printer 10 is provided with the housing 12, the roll paper attachment unit 14 as an example of an attachment section, a paper supply section 16, a paper discharge section 18, and an operating panel 20.

The housing 12 is a box in which are stored the various structural components of the printer 10.

The roll paper attachment unit 14 is for attachment of the roll paper 1 and holds the roll paper 1 which has been attached. The roll paper 1 is provided with a core 3 and print paper wrapped around the external circumference of the core 3. Note that the “roll paper” means the core 3 and the print paper wrapped around the external circumference of the core 3, but in a narrow sense it also means only the print paper.

The roll paper attachment unit 14 is provided with holders 14a. The holders 14a are placed such that they forms a pair on both sides of the printer 10 in the rear thereof and hold the roll paper 1 such that the roll paper 1 is pinched from both sides. Note that the roll paper attachment unit 14 is provided also with an attachment detection sensor (not shown) for detecting that the roll paper 1 has been attached to the roll paper attachment unit 14.

The paper supply section 16 is an insertion hole provided on the rear surface of the printer 10 for inserting the roll paper 1 into the housing 12. The paper discharge section 18 is an ejection hole provided on the front surface of the printer 10 for discharging the roll paper 1 out of the housing 12. In other words, the printer 10 is provided with a configuration in which the roll paper 1 which has been inserted through the rear surface is discharged from the front surface. Note that the printer 10 is also provided with a paper discharge tray 19 which blocks the paper discharge section 18 when the printer 10 is not in use.

The operating panel 20 is provided on the front surface of the printer 10 and is provided with operating buttons 20a and a liquid crystal display section 20b. The user can give the printer 10 various instructions by operating the operating button 20a while referring to the information (menu screens and so on) displayed on the liquid crystal display section 20b.

<<<Internal Configuration of Printer 10>>>

Next, the internal configuration of the printer 10 is described with reference to FIG. 4 and FIG. 5. The printer 10 can print color images, and can for example form print images by ejecting color ink in the four colors of cyan (C), magenta (M), yellow (Y), and black (K) on the roll paper 1 and forming dots. Note that in addition to the above-mentioned four colors, it is also possible to use light cyan (pale cyan; LC), light magenta (pale magenta; LM), dark yellow (dim yellow; DY), and light black (pale black; LK) and the like as the color inks.

The printer 10 is provided with a carrying unit 25, a carriage unit 30, a head unit 35, a cutter unit 40, a detector group 45, a timer 50, and a controller 60.

The carrying unit 25 is for sending the roll paper 1 to a printable position and carrying the roll paper 1 by a predetermined carrying amount in a predetermined carrying direction during printing. The carrying unit 25 is provided with a plurality of rollers for supplying, carrying, and discharging the roll paper 1, motors for applying turning force to the rollers, a platen for supporting the roll paper 1 during printing, and so on. (FIG. 5 shows some of these components, namely, the carrying roller 26, the discharge roller 27, and the platen 28.) The carrying unit 25 can feed back the roll paper 1 by rotating the rollers in reverse using the motors.

The carriage unit 30 is for moving the print head 36 (FIG. 5) in a predetermined movement direction (in FIG. 5, a direction perpendicular to the paper surface). The carriage unit 30 is provided with a carriage 31 (FIG. 5) as an example of a moving member, a carriage motor for moving the carriage 31, and so on. The carriage 31 is equipped with the print head 36, and the carriage 31 can move forward and back in the movement direction. With this, the print head 36 moves along the movement direction.

Further, the carriage 31 includes an optical sensor 46 (FIG. 5) as an example of the reading member and a bar code reader 47 (FIG. 5), and these move in the movement direction according to movement of the carriage 31. Note that the carriage 31 detachably holds an ink cartridge containing ink.

The head unit 35 is for ejecting ink onto the roll paper 1. The head unit 35 is provided with the print head 36, and so on. The print head 36 is provided with a plurality of nozzles, which are ink ejecting sections, and ejects ink intermittently from each of the nozzles. The print head 36 is provided in the carriage 31. For this reason, when the carriage 31 moves in the movement direction, the print head 36 also moves in the movement direction. A dot line (raster line) is formed on the roll paper 1 in the movement direction as a result of the print head 36 intermittently ejecting ink while moving.

The cutter unit 40 is for cutting the roll paper 1 and separating the printed section of the roll paper 1. The cutter unit 40 is provided with a cutter 41 (FIG. 5) which is an example of a cutting member and which is provided with a rotary blade, and a motor for turning the rotary blade and moving the cutter 41 along the movement direction of the carriage 31, and so on. The roll paper 1 is cut when the cutter 41 moves in the direction while the rotary blade is turning.

The detector group 45 includes the optical sensor 46, the bar code reader 47, and the attachment detection sensor, mentioned above, as well as a linear encoder, a rotary encoder, a temperature and humidity sensor, and so on. The optical sensor 46 reads a mark sheet (note: a computer-recognizable multiple-choice marking sheet) which is described below, as a result of a light-receiving section detecting reflected light of the light that has been irradiated onto the roll paper 1 from a light-emitting section. The linear encoder is for detecting the position of the carriage 31 in the movement direction. The rotary encoder is for detecting the amount of rotation of the carrying roller 26. The temperature and humidity sensor is for detecting the temperature and humidity in the printer 10.

The timer 50 is a clock for obtaining the current time and date.

The controller 60 is for controlling the printer 10. As shown in FIG. 4, the controller 60 is provided with an interface section 62, an image buffer 64, a CPU 66, a memory 68, and a unit control circuit 70. The interface section 62 is for sending and receiving data and signals to and from the computer 702. The image buffer 64 is for storing the print data PD. The CPU 66 is a computer processing device for carrying out overall control of the printer. The memory 68 is for reserving, for example, a work region and a region for storing programs and other data, and is provided with a RAM or an EEPROM, etc. The unit control circuit 70 is for controlling the various units (the carrying unit 25, the carriage unit 30, the head unit 35, and the cutter unit 40).

When the controller 60 receives the print data PD and the control signals COM from the computer 702 by the interface section 62, the print data PD is stored in the image buffer 64. The CPU 66 controls each of the units (the carrying unit 25, the carriage unit 30, the head unit 35, and the cutter unit 40) via the unit control circuit 70 while reading the print data PD from the image buffer 64 based on the control signals COM. In this way, the controller 60 prints the print image on the roll paper 1 and appropriately cuts off the section of the roll paper ion which the print image has been printed. The detector group 45 monitors the conditions within the printer 10, and it outputs the results of this detection to the controller 60. The controller 60 receives the detection results from the detector group 45, and controls the units based on these detection results.

The controller 60 according to the present embodiment can print a print image on the roll paper 1 even if the computer 702 is not electrically connected to the printer 10. In such cases, the CPU 66 creates the print data PD and the control signal COM while appropriately referencing the various types of information in the memory 68, based on the program in the memory 68. The print data PD is stored in the image buffer 64 and the CPU 66 controls each of the units while reading the print data PD from the image buffer 64 based on the control signals COM. In this way, the controller 60 prints the print image on the roll paper 1 and appropriately cuts off the section of the roll paper 1 on which the print image has been printed.

Printing Selected Information on Roll Paper

Using the print control apparatus 700 (the printer 10) according to the present embodiment, it is possible to print, on the roll paper 1, the pieces of information (hereafter referred to as the “selected information”) selected by the user from among the plurality of pieces of information about the roll paper 1 and the print control apparatus 700 (the printer 10). In other words, the user can select the information to be printed on the roll paper 1 when printing information about the roll paper 1 and information about the print control apparatus 700 (the printer 10).

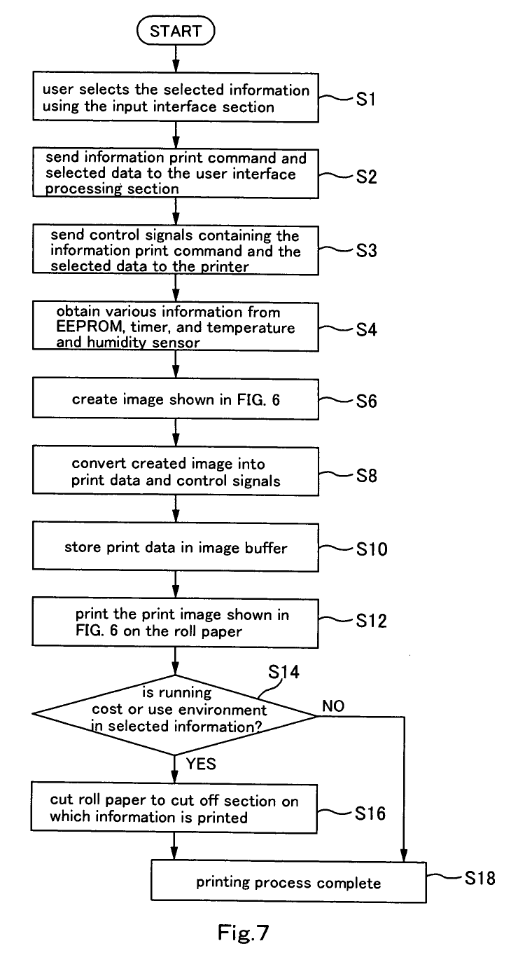

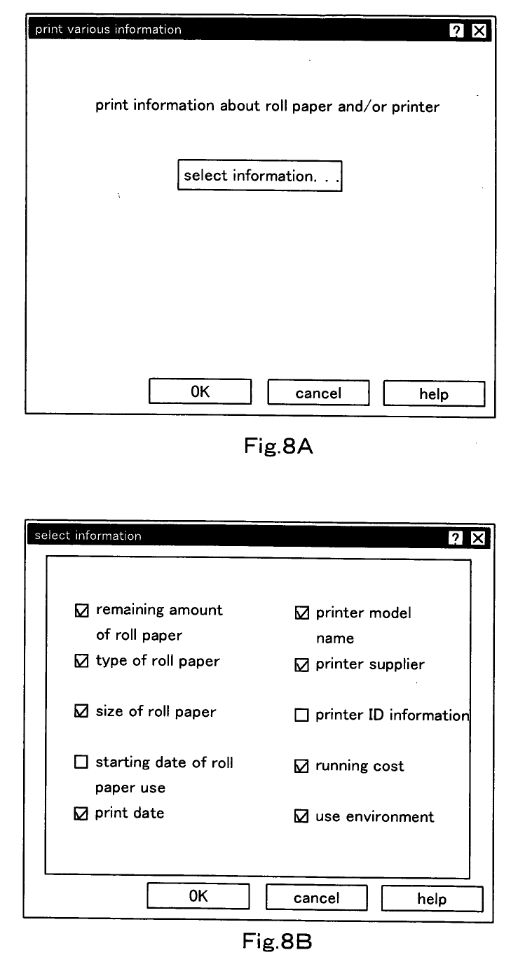

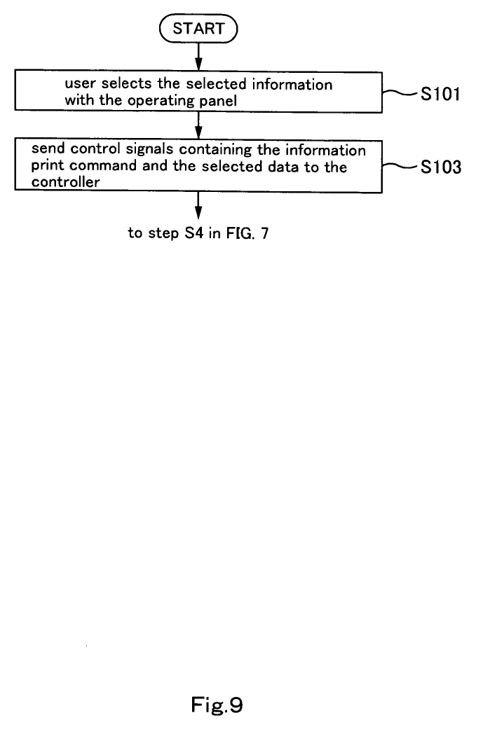

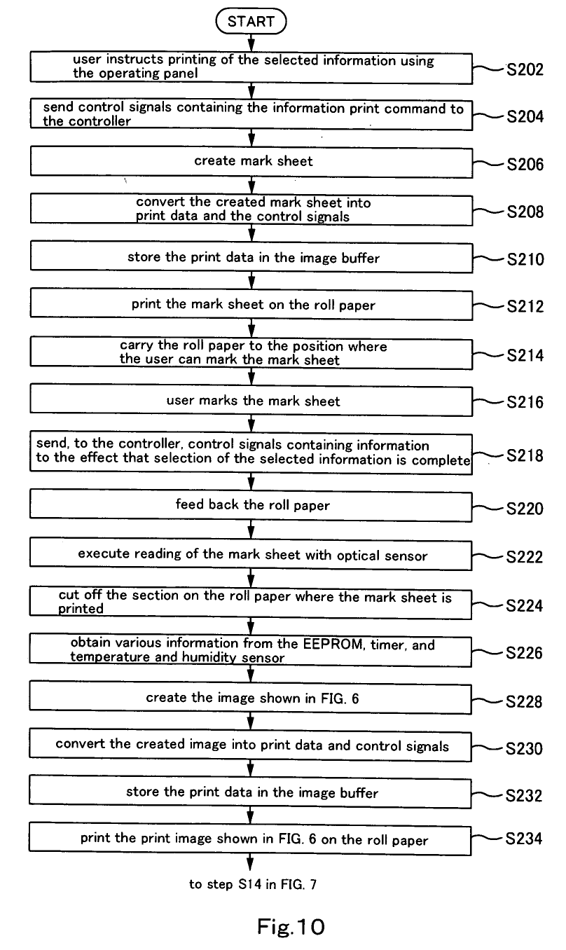

Hereinafter, printing the selected information to the roll paper 1 will be described with reference to FIG. 6. FIG. 6 is a schematic diagram showing how the selected information is printed on a roll paper 1.

The information about the roll paper 1 that the print control apparatus 700 (the printer 10) according to the present embodiment can print using the above-mentioned controller 60 is: the remaining amount information of the roll paper 1, the paper type information of the roll paper 1, the size information of the roll paper 1, and the use start date of the roll paper 1. The information about the print control apparatus 700 (the printer 10) that can be printed is the model name of the printer 10, the supplier information of the printer 1, and ID information for specifying the individual printers 10. Interpreted in a broad sense, information about the print control apparatus 700 (the printer 10) that can be printed includes: information indicating running cost of the printer 10 (hereafter simply referred to as the “running cost”), information indicating the use environment of the printer 10 (hereafter simply referred to as the “use environment”), and the date that these pieces of information were printed.

Additional description of the above types of information follows. The information on the remaining amount of the roll paper 1 is information which indicates, for example, how many meters of the roll paper 1 remain. The paper type information of the roll paper 1 is information which indicates, for example, the type of paper (plain paper, exclusive use paper, other types of specialized paper such as glossy paper, etc.). The size information of the roll paper 1 is information which indicates the size (A4, B5, etc.) of the roll paper 1. The use start date of the roll paper 1 is information which indicates the date the roll paper 1 was opened and the roll paper 1 was first attached to a printer.

The model name of the printer 10 is the name of the model of the printer 10. The supplier information of the printer 10 is the name of the supplier which supplies the printer 10, a logo expressing the supplier, and so on. Here, the supplier may be a manufacturer of the product, a person who manufactures and sells the product, or a person who does not manufacture but sells the product having received it as an OEM product from the manufacturer. The ID information which specifies individual instances of the printer 10 is, for example, a manufacturer's ID number of the printer 10.

The running cost is the cost incurred through printing print images on the roll paper 1. In other words, the running cost is the price of the ink and the roll paper 1 consumed in the course of printing the print images on the roll paper 1. In the present embodiment, the average cost per unit length (e.g., 1 meter) of the roll paper 1 is printed as the running cost of the printer 10, but it is not limited to this. It is also possible to print the average cost per page, for example. The use environment is the operating environment when using the printer 10. For example, temperature and humidity apply to this.

The user selects one to ten types of information from among the above-mentioned ten types of information, and the selected information that has been selected is printed on the roll paper 1 by the above-mentioned controller 60. FIG. 6 shows how the remaining amount information, the paper type information, the size information, the model name, the supplier information, the running cost, the use environment, and the date these pieces of information were printed is selected as the selected information and these are printed on the roll paper 1. As shown in FIG. 6, these eight types of information are converted into a bar code which can be read by the bar code reader and also printed in the form of a bar code.

Of the above information, the remaining amount (or total amount) of the roll paper 1, the paper type information of the roll paper 1, and the size information of the roll paper 1 are pieces of information which are printed on the roll paper 1 in the form of a bar code before the roll paper 1 is shipped (e.g., when the roll paper 1 is manufactured at a factory). In this case, a flag (information) which indicates that the above information, converted into a bar code, has been printed before the roll paper 1 was shipped is printed on the roll paper 1 in the form of a bar code.

Operation of Print Control Apparatus, Etc.

Next, three examples are described regarding the operation of the print control apparatus 700 etc. of making the user select the selected information and printing the selected information which has been selected.

### FIRST EXAMPLE

First, a first example will be described with reference to FIG. 7, FIG. 8A, and FIG. 8B. FIG. 7 is a flowchart for describing operation of the print control apparatus 700. FIG. 8A and FIG. 8B are views showing user interface screens of the printer driver 796.

The flowchart begins with the user selecting the selected information through the input interface section 803 (step S1). For example, the user uses the input device 708 to display the user interface screen of the printer driver 796 shown in FIG. 8A on the display device 704. With the mouse 708B, the user clicks the “select information . . . ” button to display the screen (FIG. 8B) for selecting the selected information. The user selects the selected information by adding or removing check marks in the screen. After selection is completed, the user clicks “OK” with the mouse 708B and the selection of the selected information is accepted by the input interface section 803. Thus, in the present example, the input interface section 803 acts as a selection accepting section for accepting selection of the selected information by the user. As shown in FIG. 8B, in the present embodiment, the eight types of information mentioned above are selected as the selected information.

In the screen shown in FIG. 8B, when the user clicks “OK” with the mouse 708B, the screen disappears, making it possible to operate in the screen shown in FIG. 8A again. Here, the user clicks “OK” with the mouse 708B and an information print command to print the selected information is accepted by the input interface section 803. The input interface section 803 sends the information print command to the user interface processing section 805 together with data which indicates the selected information selected by the user (hereinafter, referred to as “selected data”) (step S2). After the user interface processing section 805 receives this, it sends the control signals COM, which contain the information print command and the selected data, to the printer 10 (step S3).

When the controller 60 of the printer 10 receives the control signals COM by the interface section 62, the CPU 66 in the controller 60 creates the image shown in FIG. 6 based on the information print command contained in the control signals COM. When this happens, first the CPU 66 receives, from the EEPROM, selected information which was selected by the user, in other words, the information about the model name of the printer 10, the supplier of the printer 10, the remaining amount of the roll paper 1, the paper type of the roll paper 1, the size of the roll paper 1, and the running cost, based on the selected data contained in the control signals COM (step S4).

The information about the printer 10 (information about the model name of the printer 10, the supplier of the printer 10, and the ID specifying individual instances of the printer 10) is stored in the EEPROM ahead of time as information which does not change, but information about the roll paper 1 (information about the remaining amount of the roll paper 1, the paper type of the roll paper 1, the size of the roller paper 1, and the use start date of the roll paper 1) and information indicating the running cost is managed inside the controller 60 so that the latest and accurate information is always stored in the EEPROM. The CPU 66 also obtains the current date from the timer 50 and the temperature and humidity from the temperature and humidity sensor, based on the selected data (step S4).

A description follows of how the controller 60 manages the information about the roll paper 1 and the information which indicates the running cost.

First, the information about the roll paper 1 is described. When a new roll paper 1 is attached to the roll paper attachment unit 14, the attachment detection sensor detects the attachment of the roll paper 1. As described above, the remaining amount (total amount) of the roll paper 1, the paper type information of the roll paper 1, and the size information of the roll paper 1, as well as a flag indicating the fact that this information, converted into a bar code, has been printed on the roll paper 1 before shipment, are printed on the new roll paper 1 in the form of a bar code. The controller 60 reads this information by operating the bar code reader 47 while moving the carriage 31, based on the output of the attachment detection sensor. The controller 60 stores the remaining amount (total amount) of the roll paper 1, the paper type information of the roll paper 1, and the size information of the roll paper 1, which have been read, in the EEPROM. Further, the flag is interpreted, the current date is obtained from the timer 50, and the information about this date is stored in the EEPROM.

The attachment detection sensor detects the attachment of the roll paper 1 also when the roll paper 1 is again attached to the roll paper attachment unit 14 in order to reuse the roll paper 1 after the user has removed that roll paper 1 from the print control apparatus 700 before using up the roll paper 1 (in other words, if a not-new roll paper 1 is attached). As described above, the print control apparatus 700 can convert into a bar code and print the information about the roll paper 1 (the remaining amount information of the roll paper 1, the paper type information of the roll paper 1, the size information of the roll paper 1, and the information about the use start date of the roll paper 1) on the roll paper 1. Accordingly, when this information is printed on the roll paper 1 in the form of a bar code, the controller 60 reads this information by operating the bar code reader 47 while moving the carriage 31, based on the output of the attachment detection sensor. The controller 60 stores the read information in the EEPROM. On the other hand, if this information is not printed on the roll paper 1 in the form of a bar code, the controller 60 detects that the information, converted into a bar code, has not been printed by operating the bar code reader 47 and prompts the user to input the information. At this time, the information input by the user is stored in the EEPROM.

Of the information mentioned above related to the roll paper 1, the paper type information of the roll paper 1, the size information of the roll paper 1, and the information about the use start date of the roll paper 1 are information that does not change as long as the roll paper 1 is not attached or removed, but the information about the remaining amount of the roll paper 1 is information which changes according to use of the print control apparatus 700. This information is, for example, continuously updated by calculating the consumption amount of the roll paper 1 based on the rotation amount of the carrying roller 26 detected by the above-mentioned rotary encoder and subtracting the calculated consumption amount from the remaining amount.

The information indicating running cost is described next. The consumption amount of the roll paper 1 and the ink is calculated for each print job, for example. As described above, the consumption amount of the roll paper 1 is calculated here based on the rotation amount that the carrying roller 26 detected by the rotary encoder. On the other hand, the consumption amount of the ink is calculated based on the image data AD when the above-mentioned printer driver 796 converts the image data AD into the print data PD. The calculated consumption amount of ink is sent to the controller 60 as a control signal COM together with the print data PD. On the other hand, the price per unit amount of the roll paper 1 and the ink is stored as a database in the EEPROM, and the controller 60 calculates the cost based on a calculation equation (price of the ink×consumption amount of the ink+price of the roll paper 1×consumption amount of the roll paper 1). It is also possible to prompt the user to input the price of per unit amount of the roll paper 1 and the ink when the roll paper 1 or an ink cartridge is mounted. In this case, the information (prices) input by the user is stored in the EEPROM.

In this way, the controller 60 updates the total cost by calculating for every print job the cost incurred when printing the print images for that print job and adding that cost to the costs incurred in the past (the total cost). The controller 60 similarly updates the consumption amount of the roll paper 1. The controller 60 calculates the running cost (how much cost has been incurred on average per unit length of the roll paper 1) based on the calculation equation (the updated total cost÷the updated consumption amount of the roll paper 1) and updates the running cost.

Now the description continues, returning to the flowchart shown in FIG. 7. After the CPU 66 has obtained the model name of the printer 10, the supplier of the printer 10, the remaining amount of the roll paper 1, the paper type of the roll paper 1, the size of the roll paper 1, the running cost, the use environment, and the information about the current date as described above, it creates the image shown in FIG. 6 containing this selected information (step S6). The CPU 66 converts the created image into the control signals COM and the print data PD for printing this as a print image (step S8) and stores the print data PD in the image buffer 64 (step S10). The CPU 66 controls each of the units while reading the print data PD from the image buffer 64 and prints the print image (the selected information) shown in FIG. 6 on the roll paper 1, based on the control signals COM (step S12).

Next, based on the above-mentioned selected data (the selected information which was selected), the controller 60 determines whether or not to cut the roll paper 1 by operating the cutter 41 after printing the selected data. For example, if at least either one of the information indicating the running cost and the information indicating the use environment has been selected by the user as the selected information, the controller 60 determines that the roll paper 1 is to be cut, but if this is not the case, then the controller 60 determines that the roll paper 1 is not to be cut (step S14). In the present embodiment, both pieces of the above information have been selected by the user as the selected information, so the controller 60 determines that the roll paper 1 is to be cut.

If it is determined that the roll paper 1 is to be cut (step S14: Yes), then the controller 60 cuts the roll paper 1 by operating the cutter 41, cuts off the section of the roll paper 1 on which the selected information is printed (step S16), and completes the printing process (step S18). If, however, it is determined that the roll paper 1 is not to be cut (step S14: No), then the controller 60 completes the printing process (step S18) without cutting the roll paper 1 with the cutter 41.

### SECOND EXAMPLE

Next, a second example will be described with reference to FIG. 9. FIG. 9 is a flowchart for describing operation of the printer 10.

In the first example described above, an example was described in which the user selects the selected information using the input interface section 803 provided in the printer driver 796. In this example, however, the user selects the selected information using the operating panel 20 provided on the printer 10. The following description is made with references to the flowchart in FIG. 9.

The flowchart begins with the user selecting the selected information in the operating panel 20 (step S101). For example, the user first operates an operating button 20a to display a screen for selecting the selected information on the liquid crystal display section 20b. Referring to the screen, the user operates the operating buttons 20a and thereby sets whether to select or not select each of the ten types of printable information. Thus, in the present example, the operating panel 20 provided on the printer 10 acts as a selection accepting section for accepting selection of the selected information by the user. Further, in the present example, the above-mentioned eight types of information are taken as having been selected as the selected information.

Once the selection is completed, when the user uses the operating button 20a to instruct that the selected information be printed, the control signals COM, containing the information print command and the selected data, are sent to the controller 60 (step S103).

When the controller 60 of the printer 10 receives the control signals COM, the CPU 66 in the controller 60 creates the image shown in FIG. 6 based on the information print command contained in the control signals. The procedure following this is the same as the procedure described in the first example (steps S4 through S18).

In this way, in this example, the selection of the selected information by the user and the printing of the selected information are performed by the printer 10, so even if the printer 10 is not electrically connected to the computer 702, it is possible to print the selected information on the roll paper 1.

### THIRD EXAMPLE

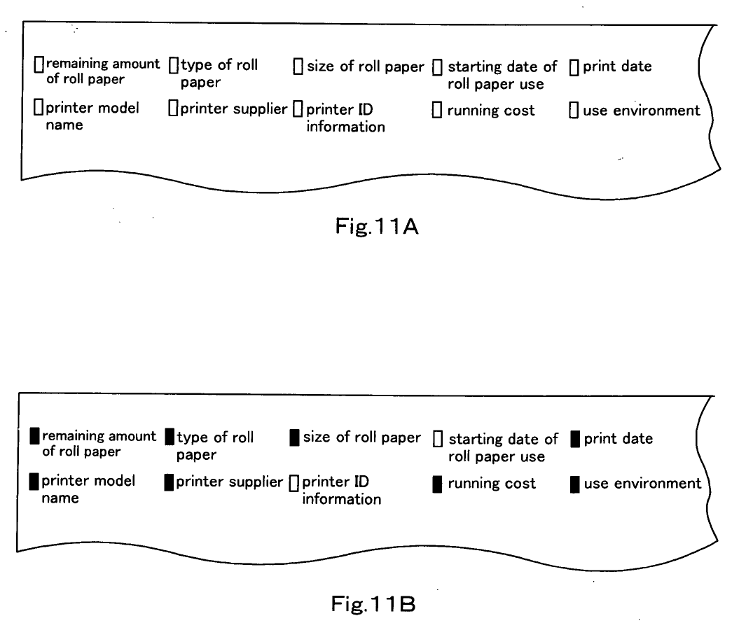

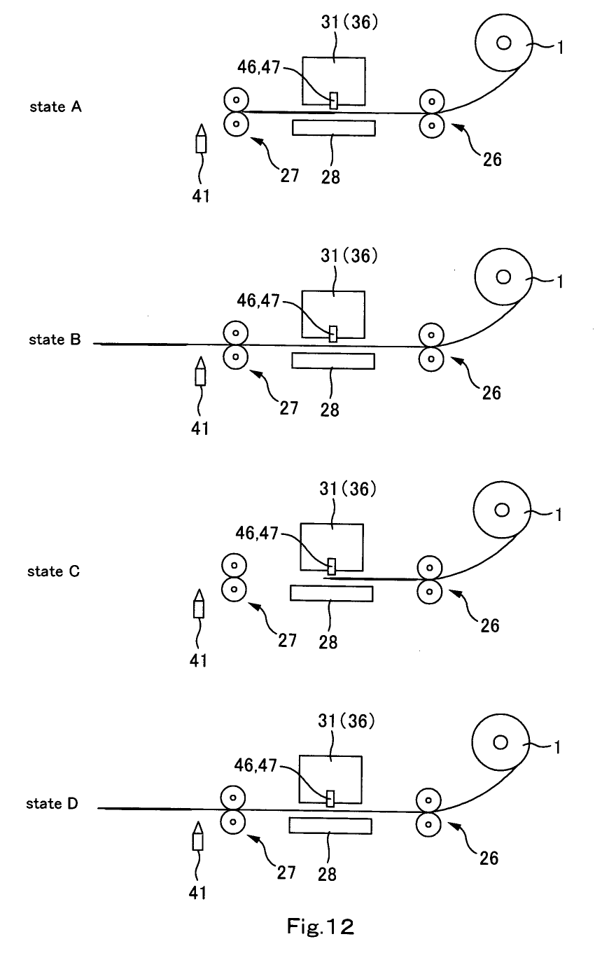

Next, a third example will be described with reference to FIG. 10 through FIG. 12. FIG. 10 is a flowchart for describing operation of the printer 10. FIG. 11A is a schematic diagram showing a mark sheet (note: a computer-recognizable multiple-choice marking sheet) printed on a roll paper 1. FIG. 11B is a schematic diagram showing how the mark sheet printed on the roll paper 1 is marked by a user. FIG. 12 is a schematic diagram showing the movement of the roll paper 1. Note that in FIG. 12 the section on the roll paper 1 where the mark sheet is printed is shown in bold.

In the first example and the second example described above, examples were described in which the selection accepting section for accepting selection of the selected information by the user is provided in the print control apparatus 700 (the printer driver 796 in the former and the printer 10 in the latter). Here, an example is described in which the selection accepting section is not provided in the print control apparatus 700.

The flowchart begins with the user instructing with the operating panel 20 that the selected information be printed (step S202). For example, the user instructs that the selected information be printed by operating the operating button 20a while referringto the liquid crystal display section 20b. At this point, no selected information has been selected.

Once the user instructs that the selected information be printed, the control signals COM containing the information print command are sent to the controller 60 (step S204). When the controller 60 of the printer 10 receives the control signals COM, the CPU 66 in the controller 60 creates the mark sheet (FIG. 11A) which is an example of an image for making the user select the selected information, based on the information print command contained in the control signals COM (step S206). The CPU 66 converts the created mark sheet into the control signals COM and the print data PD for printing as a print image (step S208) and stores the print data PD in the image buffer 64 (step S210). The CPU 66 controls each of the units while reading the print data PD from the image buffer 64 and prints the mark sheet shown in FIG. 11A on the roll paper 1, based on the control signals COM (step S212).

Next, the controller 60 controls the carrying unit 25 to carry the roll paper 1 to the position where the user can mark the mark sheet and select the selected information (step S214). In other words, the controller 60 carries the roll paper 1 from the position where printing of the mark sheet was completed as shown by state A in FIG. 12 to the position shown by state B in FIG. 12. When carrying of the roll paper 1 has been completed, the controller 60 displays on the liquid crystal display section 20b a message such as “Mark the mark sheet to select the information to be printed. When selection is complete, press button A.”

When the user sees this message, the user marks the mark sheet with a pencil or the like and selects the selected information (step S216). As shown in FIG. 1B, in the present example, the eight types of information mentioned above are selected as the selected information.

Once the user operates the operating button 20a (for example by pressing button A) to communicate to the printer 10 that the selection of the selected information is complete, the control signals COM containing information to the effect that the selection is complete, are sent to the controller 60 (step S218). When the controller 60 receives the control instructions COM, it controls the carrying unit 25 and feeds back the roll paper 1 (step S220). The controller 60 controls the optical sensor 46 together with the carrying unit 25 and the carriage unit 30 and causes the optical sensor 46 to read the mark sheet which is printed on the roll paper 1 which has been fed back (step S222). In other words, the optical sensor 46 sequentially reads whether or not each of the ten mark fields in the mark sheet shown in FIG. 11B has been marked, and sends the result, i.e. the selected data, to the controller 60.

When the controller 60 receives the selected data, it interprets that the reading of the mark sheet has been successfully completed by the optical sensor 46 and controls the carrying unit 25 and the cutter unit 40 to cut off the section of the roll paper 1 on which the mark sheet is printed (step S224). In other words, the controller 60 carries the roll paper 1 from the position at which reading of the mark sheet was completed (state C in FIG. 12) to the position where the cutter 41 cuts off the section where the mark sheet is printed (state D in FIG. 12). By operating the cutter 41 to cut the roll paper 1, the section of the roll paper 1 where the mark sheet is printed is cut off.

Next, the controller 60 prints on the roll paper 1 the selected information specified based on the mark sheet which was read by the optical sensor 46.

First the CPU 66 on the controller 60 receives from the EEPROM the information about the model name of the printer 10, the supplier of the printer 10, the remaining amount of the roll paper 1, the paper type of the roll paper 1, the size of the roll paper 1, and the running cost, based on the selected data received from the optical sensor 46 (step S226). The CPU 66 also obtains the current date from the timer 50 and the temperature and humidity from the temperature and humidity sensor, based on the selected data (step S226). When the CPU 66 obtains this information, it creates the image shown in FIG. 6 (step S228). The CPU 66 converts the created image into the control signals COM and the print data PD for printing as a print image (step S230) and stores the print data PD in the image buffer 64 (step S232). The CPU 66 controls each of the units while reading the print data PD from the image buffer 64 and prints the print image (the selected information) shown in FIG. 6 on the roll paper 1, based on the control signals COM (step S234).

The procedure following this is the same as the procedure described in the first example (steps S14 through S18).

In this way, in the present example, the selected information can be selected using the mark sheet. For this reason, there is no need to operate the printer 10 or the computer 702 when selecting the selected information. Accordingly, it is possible to realize a printer 10 having a high level of convenience for users who are not familiar to operating such devices.

In the above, the user uses the operating panel 20 to instruct that the selected information be printed and the user uses the operating panel 20 to communicate to the printer 10 that the selected information has been selected, but this is not a limitation. For example, it is also possible to perform these procedures using the input interface section 803 on the printer driver 796.

Effectiveness of the Printer 10, etc., According to the Present Embodiment

As described above, the printer 10 according to the present embodiment is provided with a controller 60 for printing, on the roll paper 1 using the print head 36, a plurality of pieces of information about at least either one of the printer 10 and the roll paper 1, and the controller prints, on the roll paper, the selected information selected by the user from among the plurality of pieces of information. This makes it possible to realize a printer 10 and a print control apparatus 700 with a high level of convenience for the user.

In other words, as described in the section “Problems to be solved by the Invention” and elsewhere, there are cases in which the user removes the roll paper 1, which is attached to the printer 10, from the printer 10 before using up the roll paper 1. As an example, this situation arises when the user exchanges the roll paper attached to the printer 10 for another type of roll paper in order to perform printing on a different type of roll paper 1.

When the user does not use the removed roll paper 1 for a certain period of time, the user has to store that roll paper 1, but the following problems might arise when reusing that roll paper 1. Namely, there is a possibility that the user might get confused regarding whether or not attaching the roll paper 1 to the printer 10 and using it is appropriate, or which printer 10 to attach the roll paper 1 on.

In order to resolve such problems, a printer 10 which can print on the roll paper 1 a plurality of pieces of information about the above-mentioned roll paper 1 and the printer 10, is effective. If this information is printed when the user removes the roll paper 1 from the printer 10 before using it up, the user can refer to this information when reusing the roll paper 1 to determine whether or not it is appropriate to attach and use the roll paper 1 on the printer 10 and which printer 10 to attach the roll paper 1 on.

For example, the user can refer to the remaining amount information of the roll paper 1 and based on whether there is a great or small amount remaining, decide whether to use that roll paper 1 or not. The user can also refer to the paper type information or the size information of the roll paper 1 and decide whether or not that roll paper 1 is the roll paper that the user wants to use. The user can also refer to the use start date of the roll paper 1 and can decide whether or not that roll paper 1 should be used after seeing how old that roll paper 1 is. The user can also know which printer 10 to attach that roll paper 1 on by referring to the model name of the printer 10, the supplier information of the printer 10, or the ID information which specifies individual instances of the printer 10.

On the other hand, there are also cases where the user wants to select a few of the plurality of pieces of information and have only the selected pieces of information be printed on the roll paper 1, when taking into consideration conserving the roll paper 1. For example, this situation arises when the user considers it unnecessary for all the information to be printed on the roll paper 1 for determining whether it is appropriate to attach and use the roll paper 1 on the printer 10 and which printer 10 to attach the roll paper 1 on. This situation arises also when the user simply want to see only a few of the plurality of pieces of information, and not determine whether or not it is appropriate to attach and use the roll paper 1 on the printer 10 and which printer 10 to attach the roll paper on.

The printer 10 according to the present embodiment can meet such user needs because it prints on the roll paper 1 the selected information which the user selected from among the plurality of pieces of information. Accordingly, this embodiment realizes a printer 10 and a print control apparatus 700 with a high level of convenience for the user.

### Other Embodiments

A printing apparatus etc. of the present invention was described above according embodiments thereof, but the foregoing embodiments of the invention are for the purpose of elucidating the present invention and are not to be interpreted as limiting the present invention. The invention can of course be altered and improved without departing from the gist thereof and includes equivalents.

In the above embodiments, an ink jet printer 10 was described as an example of a printing apparatus, but this is not a limitation. For example, printing apparatuses such as dot-impact printers also apply to the present invention.

In the above embodiments, the selected information is selected from among information about the printer 10 and information about the roll paper 1, but this is not a limitation. For example, it is also possible to select the selected information only from the information about the printer 10 and it is also possible to select the selected information only from the information about the roll paper 1.

The above embodiments were described using the model name of the printer 10, the supplier information of the printer 10, and the ID information specifying individual instances of the printer 10 as examples of information about the printer 10, but this is not a limitation. For example, it is also possible to use information which indicates whether a printer is a color printer or a monochrome printer.

The above embodiments were described using the remaining amount information of the roll paper 1, the paper type information of the roll paper 1, the size information of the roll paper 1, and information showing the date when the roll paper 1 was first attached (the use start date of the roll paper 1) as examples of information about the roll paper 1, but this is not a limitation. It is also possible, for example, to use color information of the roll paper 1 or supplier information of the roll paper 1.

The above embodiments were described using the information showing the running cost, the information showing the use environment, and the date when the information was printed as information about the printer 10 interpreted broadly, but this is not a limitation. For example, it is also possible to use parameters related to printing conditions (printer driver setting information).

In the above embodiments, the optical sensor 46 is provided as a reading member to the carriage 31, which acts as a movable moving member provided with the print head 36, but this is not a limitation. For example, it is possible to read the mark sheet with a non-moving reading member (for example a CCD camera), and it is also possible for the optical sensor 46 to be provided in another moving member which is different from the carriage 31.

However, if the optical sensor 46, as a reading member, is provided on a moving member, it is possible to realize the reading of the mark sheet with a simple apparatus configuration. Further, if the optical sensor 46 is provided on the carriage 31, it is possible for the print head 36 and the optical sensor 46 to share the moving member. Accordingly, the above embodiments are more preferable in terms of these points.

In the above embodiments, the controller 60 prints the mark sheet on the roll paper 1 and feeds back the roll paper 1 after the user has selected the selected information in the mark sheet, the optical sensor 46 reads the mark sheet printed on the roll paper 1 which has been fed back, and the controller 60 prints, on the roll paper 1, the selected information which was specified based on the mark sheet which was read by the optical sensor 46, but this is not a limitation.

For example, it is also possible for: the controller 60 to print the mark sheet on the roll paper 1, cut the roll paper 1 with the cutter 41, thereby cutting off the section where the mark sheet was printed, and supply the mark sheet after the user has selected the selected information on the cut-off mark sheet and has set the mark sheet on the printer 10; the optical sensor 46 to read the supplied mark sheet; and the controller 60 to print on the roll paper 1 the selected information specified based on the mark sheet which the optical sensor 46 read.

In the case of the above embodiments, it is possible to eliminate the labor of the user setting the mark sheet in the printer 10. This also makes it possible to avoid the problem arising of the user setting the mark sheet with the wrong side down and the reading of the mark sheet not being performed successfully by the optical sensor 46. Accordingly, the above embodiments are more preferable in terms of these points.

In the above embodiments, the controller 60 determines, based on the selected information which the user selected, whether or not to cut the roll paper 1 by operating the cutter 41 after printing the selected information, but this is not a limitation. For example, it is possible to cut the roll paper 1 after the selected information has been printed normally, regardless of the selected information which the user selected, or it is also possible not to cut the roll paper 1 at all after the selected information has been printed, regardless of the selected information which the user selected.

As described above, the user wants to print the selected information on the roll paper 1 under several different circumstances. For example, the user will instruct printing of the selected information on the roll paper 1 for the purpose (hereafter referred to as the first purpose) of being able to determine whether it is appropriate or not to attach and use the roll paper 1 on the printer 10 and which printer 10 to attach the roll paper 1 on by referring to the selected information when reusing the roll paper 1 which has been removed. The user will also instruct printing of the selected information on the roll paper 1 for the purpose (hereafter referred to as the second purpose) simply of seeing the selected information, and not for determining whether or not it is appropriate to attach and use the roll paper 1 on the printer 10 or which printer 10 to attach the roll paper 1.

In cases where the user prints the selected information on the roll paper 1 for the first purpose, then it is preferable not to cut the roll paper 1 after the selected information is printed in order to allow the user to be able to reliably refer to the selected information when the user reuses the roll paper 1; whereas in cases where the user prints the selected information on the roll paper 1 for the second purpose, it is preferable to cut the roll paper 1 after the selected information is printed in order to make it possible to hold and look at or move the paper on which the selected information is printed.

On the other hand, there are many cases in which the selected information which the user selects from among the plurality of pieces of information when printing the selected information on the roll paper 1 for the first purpose, differs from the selected information which the user selects from among the plurality of pieces of information when printing the selected information on the roll paper 1 for the second purpose. For example, the information showing the running cost, from among the above-mentioned ten types of information, is information which can be printed to meet mainly the user need of knowing at any time the running cost, so it is rare that the user would select the information showing the running cost when printing the selected information on the roll paper 1 for the first purpose. Similarly, the information showing the use environment is information which can be printed mainly to allow the user to refer to the information showing use environment when a problem arises with the printer 10 and isolate the cause of the problem, so it is rare that the user would select the information showing the use environment when printing the selected information on the roll paper 1 for the first purpose. On the other hand, the four types of information about the roll paper 1 are information which is frequently selected when the user prints the selected information on the roll paper 1 for the first purpose, although the four types of information about the roll paper 1 may be selected when the user prints the selected information on the roll paper 1 for the second purpose.

Therefore, it will be possible to make a decision as to whether or not to cut the roll paper while taking into consideration the purpose of the user printing the selected information on the roll paper, by, for example, selecting cutting of the roll paper 1, which is preferable when the selected information is printed on the roll paper 1 for the second purpose, in cases where the user has selected information on the running cost or the use environment, which is information that is often not selected when the user prints the selected information on the roll paper 1 for the first purpose, and selecting not to cut the roll paper 1 in other cases, as in the flowchart of FIG. 7. Another example of an effective way of deciding whether or not to cut the roll paper would be to select not to cut the roll paper 1, which is preferable when the selected information is printed on the roll paper 1 for the first purpose, in cases where the user has selected information on the roll paper 1, which is information that is likely to be selected when the user prints the selected information on the roll paper 1 for the first purpose, and to select cutting of the roll paper 1 in other cases.

In this way, it is possible to further increase the convenience for the user by deciding whether or not to cut the roll paper 1 after the selected information has been printed based on the selected information which is selected by the user. For this reason, the above embodiments are more preferable.

In the above embodiments, creation of the image shown in FIG. 6 and the mark sheet (step S6, step S206) and conversion of the created image and the mark sheet into print data PD and control signals COM (step S8, step S208) are performed in the controller 60 of the printer 10, but this is not a limitation. For example, it is also possible to perform this creation and conversion in the printer driver 796 of the computer 702, etc.

What is claimed is:

1. A printing apparatus comprising:
an attachment section for attachment of a roll paper;
a print head for printing on the roll paper which is attached to said attachment section; and
a controller for printing, on said roll paper which is attached to said attachment section using said print head, a plurality of pieces of information about at least either one of said printing apparatus and said roll paper, wherein said controller prints, on said roll paper, selected information which has been selected by a user from among the plurality of pieces of information.

2. A printing apparatus according to claim 1, further comprising a selection accepting section for accepting the selection of said selected information by the user;
wherein said controller prints, on said roll paper, said selected information which has been selected through said selection accepting section.

3. A printing apparatus according to claim 1,
wherein said controller prints, on said roll paper, an image for making the user select said selected information;
wherein said printing apparatus comprises a reading member for reading said image, and said reading member reads said image after the user has selected said selected information using said image; and
wherein said controller prints, on said roll paper, said selected information which has been specified based on said image read by said reading member.

4. A printing apparatus according to claim 3, further comprising a movable moving member which is provided with said print head;
wherein said moving member is also provided with said reading member.

5. A printing apparatus according to claim 4,
wherein said controller prints, on said roll paper, an image for making the user select said selected information and then feeds back said roll paper after the user has selected said selected information using said image;
wherein said reading member reads said image printed on said roll paper which has been fed back; and
wherein said controller prints, on said roll paper, said selected information specified based on said image read by said reading member.

6. A printing apparatus according to claim 1, further comprising a cutting member for cutting said roll paper attached to said attachment section;
wherein said controller determines, based on said selected information which has been selected by the user, whether or not to cut said roll paper by moving said cutting member after printing said selected information.

7. A printing apparatus comprising:
an attachment section for attachment of a roll paper;
a print head for printing on the roll paper which is attached to said attachment section;
a controller for printing, on said roll paper which is attached to said attachment section using said print head, a plurality of pieces of information about at least either one of said printing apparatus and said roll paper, wherein said controller prints, on said roll paper, selected information which has been selected by a user from among the plurality of pieces of information, and also prints, on said roll paper, an image for making the user select said selected information;
a reading member for reading said image, wherein said reading member reads said image after the user has selected said selected information using said image;
a movable moving member which is provided with said printhead; and
a cutting member for cutting said roll paper attached to said attachment section;
wherein said controller prints, on said roll paper, said selected information which has been specified based on said image read by said reading member;
wherein said moving member is also provided with said reading member;
wherein said controller prints, on said roll paper, an image for making the user select said selected information and then feeds back said roll paper after the user has selected said selected information using said image;
wherein said reading member reads said image printed on said roll paper which has been fed back;
wherein said controller prints, on said roll paper, said selected information specified based on said image read by said reading member; and
wherein said controller determines, based on said selected information which has been selected by the user, whether or not to cut said roll paper by moving said cutting member after printing said selected information.

8. A print control apparatus comprising:
an attachment section for attachment of a roll paper;
a print head for printing on the roll paper which is attached to said attachment section; and
a controller for printing, on said roll paper which is attached to said attachment section using said print head, a plurality of pieces of information about at least either one of said print control apparatus and said roll paper, wherein said controller prints, on said roll paper, selected information which has been selected by a user from among the plurality of pieces of information.

9. A printing apparatus according to claim 8, further comprising a selection accepting section for accepting the selection of said selected information by the user;
wherein said controller prints, on said roll paper, said selected information which has been selected through said selection accepting section.
